(19) United States
(12) Patent Application Publication
(10) Pub. No.: US 2004/0197447 A1
(43) Pub. Date: Oct. 7, 2004

(54) Printed edible products

(76) Inventor: Paul Patrick Coyle, Kilcock (IE)

Correspondence Address: HOGAN & HARTSON LLP, ONE TABOR CENTER, SUITE 1500, 1200 SEVENTEENTH ST, DENVER, CO, 80202, US

(21) Appl. No.: 10/181,601

(22) PCT Filed: Jan. 16, 2001
(86) PCT No.: PCT/IE01/00007

(30) Foreign Application Priority Data
Jan. 17, 2000 (IE) S2000/0037

(51) Int. Cl. A23P 1/00

(52) U.S. Cl. 426/383

(57) ABSTRACT

A paper guide (10) directs an edible substrate beneath a print head using rollers (11) disposed on either side of the guide (10) and an axle (12), where edible ink is used to apply an image. By producing the substrate so that an edible portion is inset from the longitudinal edges accidental contact with the rollers is avoided. The axle (12) is biased against the rollers (11) and the substrate to maintain progress of the substrate beneath a print head without the need for rollers coming into contact with the edible portion.

The present invention relates to improvements in and relating to printed edible products and more particularly a method and apparatus for producing such products.

Decoration of cakes and similar food items to add value has become a common practice. Images are presented on the food item to both increase visual appeal and to customise the cake for specialist requirements. For example, cartoon characters are often depicted on iced cakes for children's birthday parties and seasonal scenes are often presented on cakes for special events.

A variety of presentation methods used to produce these images are known. One method uses food colourings applied with brushes by the baker or cake decorator. The skill and time available thus limit the number of images, which can be applied. Therefore, while this method may be useful for very specialist requirements, the costs involved prohibit mass marketing of the cakes so produced. An alternative to hand painting the image is to use aerosol food sprays and stencils. While this technique greatly increases number and reproducibility of such images, bleeding around the edges of the stencil prevents production of sharp images. Furthermore, to accommodate the multiplicity of colours desired, multiple application sessions are necessary, greatly reducing productivity rates. Screen printing techniques have also been employed but with similar disadvantages.

An improved solution to those described above is shown in U.S. Pat. No. 4,910,661 (Barth et al.). This document shows the use of an integrated computer system for capturing live video images and combining these or library images with text as desired, before previewing the composite image and reproducing the image on a food item. This apparatus and method described represents a significant improvement over known techniques, however, the production costs of the proposed solution limit its suitability to large scale manufacturing facilities. Small retail outlets that would otherwise prefer to offer specialist cake decoration services to their clients are prevented from doing so by the prohibitive costs involved. They can of course, obtain stock cakes produced in the manner described but this significantly reduces the adaptability of the system which makes it so attractive.

A further alternative solution is shown in International Patent Application No. WO/97/27759 (Young) in which a bubble jet printer is used. This solution overcomes the scale problems associated with U.S. Pat. No. 4,910,661 (Barth et al.), however, the edible inks involved are prone to blocking the print head causing frequent failure and blurred results. Additionally, the heat used by such print devices is not universally applicable to all food types and local singing can occur spoiling the taste of the produced item.

The substrate to which the design is applied can also produce problems, these problems can relate to both the delivery of inks and to the nature of the substrate used. For example, a commonly used paper incorporates cornstarch. This substrate paper is tasteless and inflexible. While useful for certain applications the range of potential applications is somewhat limited. Additionally, cake production may suffer from excessive wastage where the inflexibility of the substrate leads to damage and aesthetically unacceptable results. This damage can arise both in the printing process and when being removed from a backing sheet prior to application.

A more recent concern relates to the constituent components of the substrate itself Genetically Modified (GM) elements are endemic in corn production and there is a risk that consumer confidence may be compromised in using solutions known to date.

There is therefore a need for a method and apparatus for producing printed edible products, which will overcome the aforementioned problems.

Accordingly, the present invention provides a method for producing homogeneous, edible final ink for deposition on an edible substrate, the final ink being produced by performing the steps of:—

mixing distilled water, alcohol and food colour in a desired ratio in a sterilised flask;

allowing the mixed elements to sit for a given period to ensure substantially full dissolution;

adding a pre-set volume of Glycerine to the dissolved desired ratio and blending the elements until fully diluted;

allowing the fully diluted mixture to settle at room temperature for a desired period in an airtight container;

filtering the settled dilute solution; and

allowing the filtered solution further settle for a pre-set period.

Advantageously ensuring that the final ink, in whichever colour, is homogeneous and will flow evenly through a print head. Beneficially, the alcohol component will evaporate quickly on contact with the food substrate thus preventing bleeding and ensuring a sharp image is produced.

According to another aspect of the invention there is provided a method of filling one or more ink chambers of an ink cartridge, the method comprising the steps of:—

inserting a rubber grommet into an inlet opening of the or a chamber to define an airtight seal;

evacuating a volume of air from the chamber to create a vacuum;

drawing a volume of final ink into the chamber to replace the vacuum; and

removing the grommets and applying an adhesive strip to the inlet opening.

Beneficially, filling the chamber in this way prevents the accidental inclusion of air bubbles, which could block the print heads.

According to a further aspect of the invention there is provided a paper guide to deliver the final ink to an edible substrate such as cornstarch paper.

Preferably, the paper guide incorporates rollers for passing the substrate beneath the print 10 head, the rollers acting against an axle to move the substrate in response to instructions from a processing device. Beneficially, ensuring a positive contact with the axle being more forcefully pressed onto the substrate prevents slippage associated with such substrates.

Preferably, the guide provides a shortened axle seat recesses. Thus as the recesses are shallower than those associated with normal paper printers a more positive contact with the substrate is provided.

Ideally, biasing means ensures that impelling rollers maintain a positive contact with the axle.

Preferably the biasing means is provided by two contact springs acting on the rollers.

According to a still further aspect of the invention there is provided a printing device using ink produced as described or a paper guide as described.

In one arrangement of the current invention there is provided an integral printer and scanning device for use with an ink to print an image on an edible substrate.

In a particularly preferred arrangement, the edible substrate is a sugar based icing. A substrate of this type is easily applied and removed from a backing sheet. This can allow the image to be printed on any chosen printer, thereby reducing set-up costs to producers. Furthermore, the flexibility of the sugar based icing ensures that the risk of damage by comparison with inflexible cornstarch products is greatly reduced. The sugar based icing also benefits from being produced without GM components, promoting consumer confidence.

According to another aspect of the invention there is provided an apparatus for producing a printed edible product, the apparatus including:—

a paper guide of the type having contact rollers for moving an edible substrate in response to instructions from a processing device; and

an associated print head for printing an image on the substrate,

characterised in that the contact rollers are disposed on opposite sides of the paper guide and are formed for contact with an axle to move the substrate.

Ideally, the axle is positively is mounted on a shortened axle seat recesses providing positive contact between the axle and the substrate.

Preferably, the apparatus incorporates biasing means for ensuring positive contact between the rollers and the axle.

In one arrangement the biasing means is provided by a contact spring.

According to a further aspect of the invention there is provided an edible substrate for receiving a printed image of the type having an edible sheet carried on a backing sheet characterised in that a longitudinal axis of the edible sheet is spaced apart from a longitudinal edge of the backing sheet to define a contact axis.

The invention will hereinafter be more particularly described with reference to the accompanying drawings, which illustrate by way of example only, an embodiment of the invention with reference to the accompanying drawings in which:—

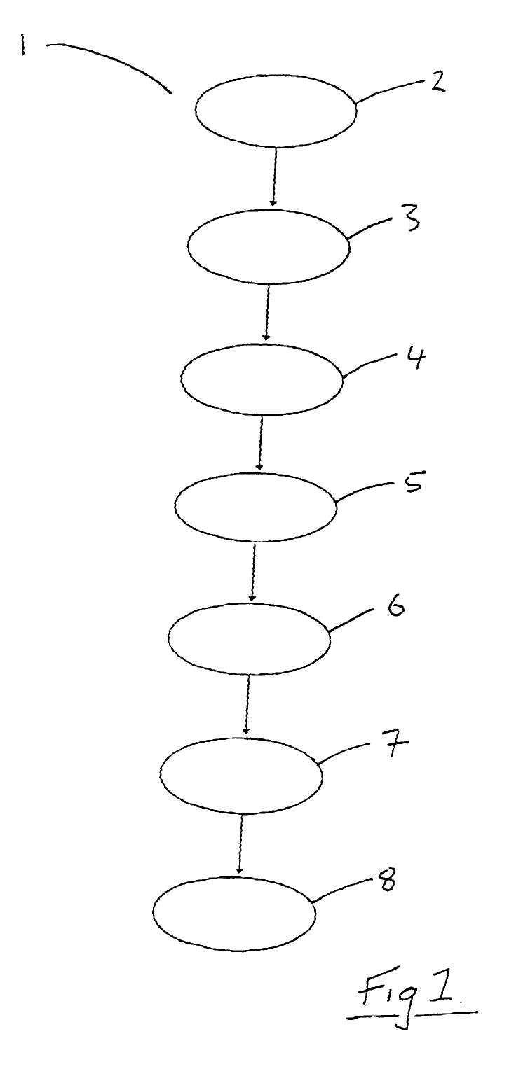

FIG. 1 is a flow chart of an ink production process forming part of the invention;

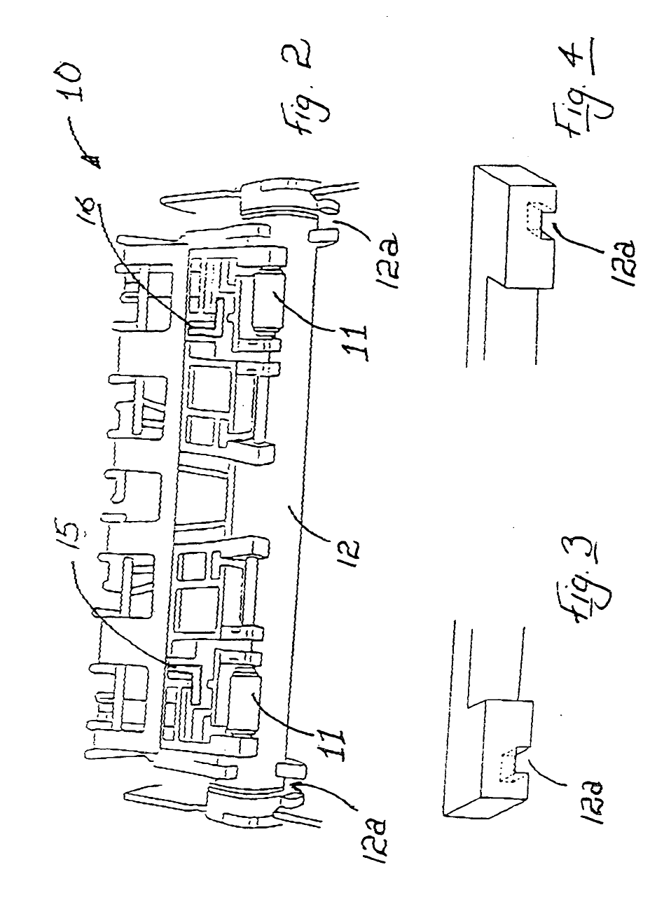

FIG. 2 is a front view of a paper guide forming part of the invention;

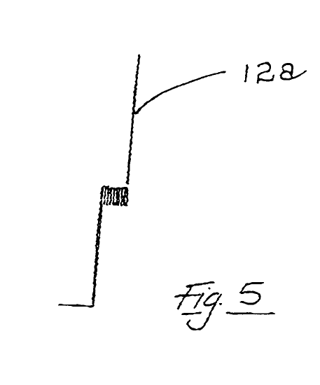

FIGS. 3 and 4 are axle seats for the paper guide of FIG. 2; and

FIG. 5 is a springed member forming part of the paper guide of FIG. 2.

Referring to the drawings and initially to FIG. 1, there is illustrated an ink production process forming part of the invention indicated generally by the reference numeral 1. The proportions and volumes described below relate to the production of 78 ml of a given colour of ink. This volume is suitable for filling one possible ink cartridge, however, it will be appreciated that the quantities may be varied to accommodate larger or smaller vessels.

Distilled water 48 ml is mixed with 10 ml of alcohol and 3 g of food colour in a sterilised flask in step 1. The use of alcohol both aids solution of the food colour and ensures rapid drying of the ink on a food substrate when printed. To produce the desired colours namely, cyan, magenta, yellow and black, tartrazine 85%, brilliant blue fcf 85%, carmoisine 85% and black are used respectively to provide the 3 g of food colour.

The elements mixed in step 1 are allowed to sit for approximately forty-eight hours in step 2 to ensure that the food colour has fully dissolved. Glycerine 20 ml is added to the mixture in step 3 and blended until fully diluted in step 4. The addition of glycerine ensures that the ink remains liquid at all times and prevents the print heads (see below) from blocking during application of the image to the food substrate. The diluted mixture of step 4 is allowed to sit at room temperature for approximately 24 hours in an airtight container in step 5. The settled dilute solution is filtered in step 6 using a 1.2 micron filter to ensure homogeneous ink is produced. This ink is then allowed to settle in step 7 for forty-eight hours to produce the final ink.

The final ink, in whichever colour, produced in this way will flow evenly through the print head and the alcohol component will evaporate quickly on contact with the food substrate preventing bleeding and ensuring a high quality, sharp image is produced.

The ink is then loaded into a chamber of a colour print cartridge before mounting the filled cartridge into a printer. Cartridges of this type typically have three chambers to accommodate the colours required. The specific details of the cartridge have been omitted in order not to unnecessarily obscure the present invention however the manner of filling the chambers is an important feature. A rubber grommet is inserted into an inlet opening to define an airtight seal, a needle is then inserted into the grommet and a volume of air withdrawn from the chamber. An equivalent volume of final ink is then inserted into the chamber using a similar needle to fill the chamber and negate the vacuum. It will be understood that filling the chamber in this way prevents the accidental inclusion of air bubbles, which could block the print heads. The grommets are then removed and an adhesive strip applied to the inlet opening. This process may be repeated for each chamber or automated with three needles defining the vacuum and injecting the final ink simultaneously from a number of reservoirs.

Referring now to FIGS. 2 to 5 there is illustrated a paper guide apparatus forming part of the invention indicated generally by the reference numeral 10. The guide 10 is used to deliver the final ink to an edible substrate. One example of such an edible substrate may be cornstarch paper. In order to produce high quality sharp images on such substrates accurate movement of the paper beneath a print head (not shown) is vital.

The paper guide 10 has rollers 11 for passing the substrate beneath the print head. The rollers 11 rotate against an axle 12 to move the substrate in response to instructions from a processing device. To overcome slippage associated with such substrates not present in conventional paper the axle is more forcefully pressed onto the substrate. This is achieved by providing shortened axle seat recesses 12a. The recesses 12a are shallower than those associated with normal paper printers to provide a more positive contact with the substrate. As the axle 12 is moved away from the rollers 11, to ensure that this contact is maintained two contact springs 14 and 15 (see FIG. 5) are located above the rollers 11.

It will be understood that the print mechanism described or any similar print mechanism may be coupled to or integrally formed with a scanning device.

It will be further understood that the invention is ideally suited to use with an edible substrate made with a sugar based icing. A substrate of this type is easily applied and removed from a backing sheet allowing the image to be produced with a variety of printers. The sugar based icing is inherently flexible thus ensuring that the risk of damage during production or application is greatly reduced.

In another aspect of the invention a method for the production of an edible substrate for use with the paper guide and final ink is now described. A sugar paste is formed by mixing

Icing sugar (47%),

Hydrogenated vegetable oil

Invert sugar

Water

Emulsifiers and

Vegetable glycerine.

This mixture is applied in a uniform layer to a backing carrier sheet so that a margin of approximately 10 mm is left uncovered along each longitudinal axis of the carrier sheet. This prevents accidental damage to the sheet during production and if required can provide a contact axis for additional rollers if required. It is important to note that the dimension of the contact axis is such as to permit engagement of the rollers against the carrier sheet without coming into contact with the edible sheet. While a similar uncovered portion may also be left along the top and bottom ends of the backing sheet to further reduce damage it is envisaged that a continuous sheet may be presented beneath the print head for continuous production and individual images separated after printing.

It will of course be understood that the invention is not limited to the specific details described herein, which are given by way of example only, and that various modifications and alterations are possible within the scope of the appended claims.

1. An apparatus for producing a printed edible product, the apparatus comprising:
a paper guide of the type having contact rollers for moving an edible substrate in response to instructions from a processing device; and
an associated print head for printing an image on the substrate, characterized in that the contact rollers are disposed on opposite sides of the paper guide and are formed for contact with an axle to move the substrate.

2. An apparatus as claimed in claim 1 wherein the axle is positively mounted on a shortened axle seat recesses providing positive contact between the axle and the substrate.

3. An apparatus as claimed in claim 1 incorporating biasing means for ensuring positive contact between the rollers and the axle.

4. An apparatus as claimed in claim 3 wherein the biasing means in provided by a contact spring.

5. A method for producing a homogeneous, edible final ink for deposition on an edible substrate produced by performing the steps of comprising:
mixing distilled water, alcohol and food colour in a desired ratio in a sterilised flask;
allowing the mixed elements to sit for a given period to ensure substantially full dissolution;
adding a pre-set volume of Glycerine to the dissolved desired ratio and blending the elements until fully diluted;
allowing the fully diluted mixture to settle at room temperature for a desired period in an airtight container;
filtering the settled diluted solution; and
allowing the filtered solution further settle for a pre-set period.

6. A method of filling one or more ink chambers of an ink cartridge, the method comprising the steps of:
inserting a rubber grommet into an inlet opening of the chamber to define an airtight seal;
evacuating a volume of air from the chamber to create a vacuum;
drawing a volume of final ink into the chamber to replace the vacuum; and
removing the grommets and applying an adhesive strip to the inlet opening.

7. An edible substrate for receiving a printed image of the type having an edible sheet carried on a backing sheet characterized in that a longitudinal axis of the edible sheet is spaced apart from a longitudinal edge of the backing sheet to define a contact axis.

8. An apparatus according to claim 2 incorporating biasing means for ensuring positive contact between the rollers and the axle.

9. An apparatus according to claim 8, wherein the biasing means is provided by a contact spring.
